(19) United States
(12) Patent Application Publication
(10) Pub. No.: US 2009/0136910 A1
(43) Pub. Date: May 28, 2009

(54) MEMORIZATION AID

(76) Inventors: Liran Mayost, Reut (IL); Ezra Hoch, D.N. Hanegev (IL); Uri Marchand, Kohav Yair (IL)

Correspondence Address: EMPK & Shiloh, LLP;c/o Landon IP, Inc., 1700 Diagonal Road, Suite 450, Alexandria, VA, 22314, US

(21) Appl. No.: 11/944,675

(22) Filed: Nov. 26, 2007

(51) Int. Cl. G09B 3/00

(52) U.S. Cl. 434/350

(57) ABSTRACT

A teaching system including a database including multiple question/answer sets, wherein substantially each question/answer set includes a question and at least one correct answer, and wherein at least two sets are adapted to test substantially a same data item; and a presentation module adapted to present to a user a second question/answer set relating to a first data item immediately following or subsequent to the user correctly responding to a first question/answer set relating to the first data item, and said presentation module further adapted to stop presenting question/answer sets related to the first data item once the user has responded correctly to two question/answer sets relating to the first data item without incorrectly responding to a question/answer set related to the first data item.

### FIELD

The invention relates to memorization aids.

### BACKGROUND

Electronic learning or e-learning is a term commonly used to refer to learning “online” via the Internet, although in its broadest sense, it is generally used to refer to computer-supported learning. E-learning typically provides a user with the flexibility, convenience and ability to learn at his or her own pace, generally without requiring the user's physical presence in a classroom or similar type of instructional setting. Many different technologies are used in e-learning such as, for example, palm computers, MP3 players, DVD players, websites, web-based teaching material, e-mail, personal computers, and mobile phones.

The advent of e-learning has supported the development of educational adaptive learning systems (ALS). Adaptive learning is defined by the Free On-Line Dictionary of Computing as “learning where a system programs itself by adjusting weights or strengths until it produces the desired output”. An educational ALS may be viewed as a system, adapted to organize educational content based on the preferences of a user and the use of continuous intelligent feedback, in order to maximize user learning performance. Three basic tasks are carried out by an ALS. The first is enabling the user to organize content by providing the user with different contexts and perspectives. The second is using diagnostic assessments to identify the best learning method preferred by the user. The third is to use the results of the diagnostic assessments as continuous intelligent feedback so as to overcome concept deficiencies and maximize learning performance. The three tasks are comprised in an iterative adaptation process which renders rapid convergence of the learning method to the user's performance. The process steps are (a) the user attempts to learn the concept based on a selected learning model, (b) the user takes diagnostic test, (c) concept deficiencies and learning model are identified, and (d) a remedial course is dynamically created with an appropriate learning model. This process is repeated until the desired level of competency is achieved. More information on adaptive learning and ALS may be found in “Adaptive Learning Technologies: From One-Size-Fits-All to Individualization”, by Nishikant Sonwalkar, EDUCAUSE Center for Applied Research, Vol. 2005, Issue 7, and in “Adaptive Learning: A Dynamic Methodology for Effective Online Learning”, Dr, Nishikant Sonwalkar, iDL Systems, (www.idlsystems.com/press/brochures/als.pdf), both of which are incorporated herein by reference.

Numerous ALS are known in the art. An example of an ALS is described in U.S. Pat. No. 6,978,115 B2, “Method and System for Training in an Adaptive Manner”, the disclosure of which is incorporated herein by reference, which describes “a learning method and system that assesses a user's understanding of the subject matter and the user's preferred learning style by presenting and reviewing the information in various types of teaching strategies and then selecting the teaching strategies in which the student learns best. As the student responds to questions presented during the course, a learning bias model is developed for the user based on which teaching styles provide the best level of comprehension for the user and then presents concepts from the course within those learning strategies most suitable to the student.”

Another example of an ALS is described in US Publication No: US 2006/0078856 A1, “System and Method for Adaptive Learning”, the disclosure of which is incorporated herein by reference, which describes “a system and method for optimized, automated learning wherein the optimal sequencing method is adaptive in the sense that it continuously monitors a student's speed and accuracy of response in answering a series of questions, performing a series of classification tasks, or performing a series of procedures, and modifies the sequencing of the items presented as a function of theses variables. One goal of the technique is to teach the subject matter in the shortest possible time. The optimal sequencing method may be used independently or in conjunction with disclosed perceptual learning and hinting methods.”

A third example of an ALS is described in U.S. Pat. No 7,153,140 B2, “Training System and Method for Improving User Knowledge and Skills”, the disclosure of which is incorporated herein by reference, which describes “a method for creating training systems including analyzing/mapping course requirements for evaluating required knowledge/skills according to mapped subjects and defining possible causes, wherein each failure cause represents knowledge/skill weakness relating a certain subject or general weakness, defining knowledge/skills target level correct/wrong answers in each subject as function of the number of users, preparing a question pool, wherein each question relates to a subject knowledge/skill and/or failure cause, preparing correct and wrong answers for each question, wherein each wrong answer is related to a specific sub-subject/subject and/or to a failure cause, defining an evaluation module for assessing user knowledge/skills level based on user's success in giving correct answers in comparison to predefined target levels and type of failure causes related to the user's wrong answers, and defining exercise module for selecting sequence of questions from predefined question set based on evaluations of user knowledge/skills level and detected failures causes.”

Despite the numerous ALS known in the art, many of which are based on the same principal of adaptive learning previously described, a major factor differentiating one from the other is the speed and efficacy with which the adaptation process converges to the desired competency level.

### SUMMARY

An aspect of some embodiments of the invention relates to providing a teaching method and a teaching system to aid a user to memorize data, also referred to hereinafter as “data item(s)”. This is achieved by the use of an adaptive converging process of memorization based on cumulative information of a user's data item knowledge levels during different stages of the memorization process.

In accordance with an embodiment of the invention the teaching system automatically classifies each data item with a knowledge level based on weighting and processing information received from a variety of user inputs such as, for example, tests and exercises. Initially, each data item is classified at the lowest knowledge level. The user prepares exercises and takes tests answering questions related to the data items. The answers are compared with previous information in the system, which includes prior exercise and test results, and the system decides whether to change the knowledge level of a data item. The classification process is iterative and is repeated every time there is a user input. The classification process ends when each and every data item is memorized, that is, when each and every data item has been positively recognized twice successively. When memorized the data items are classified at the highest knowledge level, at which time the memorization process may be said to have converged.

In an embodiment of the invention the teaching system comprises a server and one or more clients. The central server comprises a database and a presentation unit. The clients include mobile and/or immobile data storage device/means such as mobile telephone, MP3 player, DVD player, personal digital assistant (PDA), personal computer (PC), card indexes, and others.

In accordance with some embodiments of the invention, there is provided a teaching system comprising a database including multiple question/answer sets, wherein substantially each question/answer set includes a question and at least one correct answer, and wherein at least two sets are adapted to test substantially a same data item; and a presentation module adapted to present to a user a second question/answer set relating to a first data item, immediately following or subsequent to the user correctly responding to a first question/answer set relating to the first data item, and the presentation module further adapted to stop presenting question/answer sets relating to the first data item once the user has responded correctly to two question/answer sets relating to the first data item without incorrectly responding to a question/answer set on the first data item Optionally, the teaching system further comprises at least one data storage device.

In accordance with some embodiments of the invention, the data storage device comprises an immobile data storage device, Optionally, the data storage device is a client.

In accordance with some embodiments of the invention, the database is synchronized with a database comprised in the client. Optionally, data items are downloaded from the database to the client based on ranking, filtering, and sorting requirements of a user. Optionally, the client is adapted to mark a data item and to score the data item using a scoring system based on the number of marks and the number of times the data item has been reviewed by a user.

In accordance with some embodiments of the invention, the database stores the knowledge level of a data item. Optionally, the presentation module is further adapted to classify a data item according to a knowledge level. Optionally, the knowledge level is a function of any combination of a score issued to a data item, a test result, and an exercise review session.

In accordance with an embodiment of the invention, there is provided a teaching method comprising: using a database including multiple question/answer sets, wherein substantially each question/answer set includes a question and at least one correct answer, and wherein at least two sets are adapted to test substantially a same data item; and presenting to a user a second question/answer set relating to a first data item, immediately following or subsequent to the user correctly responding to a first question/answer set relating to the first data item, and the presentation module further adapted to stop presenting question/answer sets relating to the first data item once the user has responded correctly to two question/answer sets relating to the first data item without incorrectly responding to a question/answer set on the first data item. Optionally, the teaching method further comprises using at least one data storage device.

In accordance with some embodiments of the invention, the data storage device comprises an immobile data storage device. Optionally, the data storage device is a client.

In accordance with some embodiments of the invention, the teaching method further comprises synchronizing the database with a database comprised in the client Optionally, downloading a data item from the database to the client is based on the ranking, filtering, and sorting requirements of a user.

In accordance with some embodiments of the invention, the teaching method further comprises marking a data item and scoring the data item using a scoring system based on the number of marks and the number of times the data item has been reviewed by a user Optionally, the teaching method further comprises storing the knowledge level of a data item in the database. Optionally, each data item is classified according to a knowledge level. Optionally, the knowledge level is a function of a combination of the score issued to a data item, test results, and exercise review sessions.

### BRIEF DESCRIPTION OF FIGURES

Examples illustrative of embodiments of the invention are described below with reference to figures attached hereto. In the figures, identical structures, elements or parts that appear in more than one figure are generally labeled with a same numeral in all the figures in which they appear Dimensions of components and features shown in the figures are generally chosen for convenience and clarity of presentation and are not necessarily shown to scale. The figures are listed below.

FIG. 1 schematically illustrates a block diagram of an exemplary teaching system in accordance with an embodiment of the invention;

FIG. 2 schematically illustrates a flow diagram of an exemplary implementation of the algorithm used by the teaching system in accordance with an embodiment of the invention;

FIG. 3 schematically illustrates a flow diagram of an exemplary implementation of the client's database management algorithm used by the teaching system in accordance with an embodiment of the invention;

FIG. 4 schematically illustrates a flow diagram of an exemplary implementation of a client's knowledge level scoring algorithm used by the teaching system in accordance with an embodiment of the invention;

FIG. 5 schematically illustrates a flow diagram of an exemplary implementation of a test knowledge level scoring algorithm used by the teaching system in accordance with an embodiment of the invention;

FIG. 6 schematically illustrates a flow diagram of an exemplary implementation of an automatic test building algorithm used by the teaching system in accordance with an embodiment of the invention; and,

FIG. 7 schematically illustrates a flow diagram of an exemplary implementation of the knowledge levels classification algorithm used by the teaching system in accordance with an embodiment of the invention.

### DETAILED DESCRIPTION

In accordance with an embodiment of the invention there is provided a teaching method and a teaching system which allows a user, which may include a plurality of users, to memorize data, also referred to as “data items”, while managing the user's knowledge levels for each data item. The system classifies knowledge levels dynamically by means of weighing and processing a variety of inputs received from the user in different ways, for example, through exercises and tests, using memorization aid accessories, referred to hereinafter as “clients”, and a central server. Each user interfaces with the central server through one or more clients. Each client comprises a database wherein are stored the data items to be memorized by the user. The client and the central server are synchronized, so that the data items are downloaded from the central server to the client's database. Information input to the client by the user is transferred to the server during each synchronization process.

A user's knowledge level for each data item is classified as “knows”, “knows partially”, and “do not know”. A knowledge level “knows” is indicative of the user having correctly answered questions related to a data item in at least two consecutive occasions. A level of “partially knows” is indicative of the user having correctly answered questions related to a data item in one occasion or in at least two inconsecutive occasions. A level of “do not know” is indicative of the user not having correctly answered a question related to a data item at least in one occasion. Questions and answer (question/answer) sets corresponding to the data items are stored and classified according to statistical evaluation of the right and wrong responses and levels of the users. The knowledge level of a data item is then determined and subsequently dynamically updated based on statistical evaluation of the questions, answers, user levels, and response times received from the users. The teaching method and system allow for limited user resources such as, for example, time, attention, and concentration, to be focused on the user's major weaknesses while continuously directing the user to memorize data with the lowest knowledge level classifications. This leads to the execution of a converging memorization process adapted to the user.

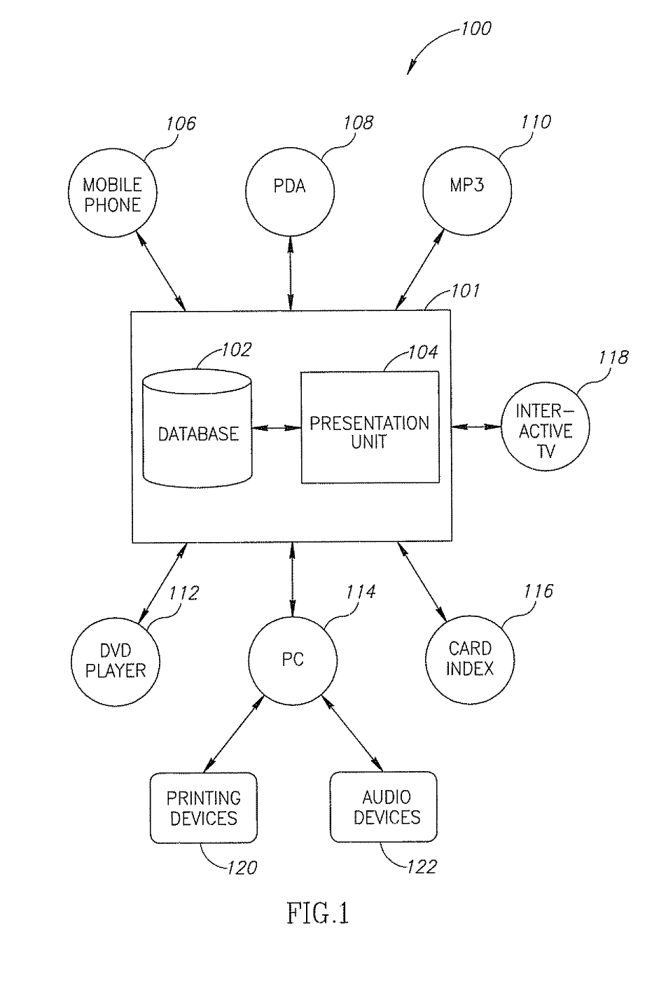

Reference is made to FIG. 1, which schematically illustrates a block diagram of an exemplary teaching system in accordance with an embodiment of the invention. Teaching system 100 comprises a central server 101 and a plurality of clients. Central server 101 comprises a database 102 and a presentation unit 104. The clients include mobile and/or immobile data storage device/means such as, for example, mobile telephones 106, personal digital assistants (PDA) 108, MP3 players 110, DVD players 112, personal computers (PC) 114, electronic card indexes 116, interactive televisions 118, assorted printing devices 120, assorted audio devices 122, and/or any combination thereof.

Presentation unit 104 is adapted with a series of algorithms for the management and execution of all processes related to user interaction with database 102. These include: client's—production process, memorization process, synchronization process, knowledge levels classification and updating process, and automatic test/exercise building process, all of which are described below.

Database 102 comprises data items in the form of text, audio, pictures, graphical representations, video, symbols, and/or any combination thereof. Each data item comprises a data portion which is intended to be memorized and is referred to as an “information portion” (IP), for example a word, a historical date, or any other any other type of data which requires memorization by the user. Additionally, each data item comprises a data portion referred to as an “information portion meaning” (IPM), for example, an interpretation, a definition, an explanation, an essence, or any other type of data, which may be used to identify, describe and/or explain the information portion. Database 102 also comprises for each and every data item the present weighted knowledge level, user inputs for the data item, and the result of weighting the last two user inputs. The database also comprises for each and every data item one or more of the following data portions: “ascription field” or category of the item, for example, to associate with “abstract concepts”, and secondary classification of the item, for example, to classify as a “Latin term”. Database 102 further comprises for each and every data item one or more of the following data portions as an aid to the memorization process: association, example of usage, links to data items related to the item, or any supplementary information that can help the memorization process.

Database 102 is adapted, through self-teaching, to automatically build questions which are presented to the user. The database is also adapted to be physically input the questions by a person or persons authorized to do so. Database 102 comprises two levels of self-teaching, a Specific User Level (SUL), and a General User Level (GUL).

At the SUL, database 102 identifies an incorrect selection (by a user) of an IPM and classifies the data item comprising the IPM as a “catch”. Additionally, database 102 associates the catch with the data item, such that the IMP of the catch is usually presented as a possible (incorrect) response to the IP of the data item, and/or opposite (the IMP of the data item is presented as a possible incorrect response to an IP of the catch). The catch is generally stored in database 102 at the SUL of the user.

At the GUL, the same catch for a plurality of users is classified by database 102 as a “general” catch. The general catch is stored at the GUL and is typically presented to all users, including new users. The general catch is associated with the data item, such that the IMP of the catch is usually presented as a possible (incorrect) response to the IP of the data item, and/or opposite (the IMP of the data item is presented as a possible incorrect response to an IP of the catch). In this manner, database 102 builds itself automatically.

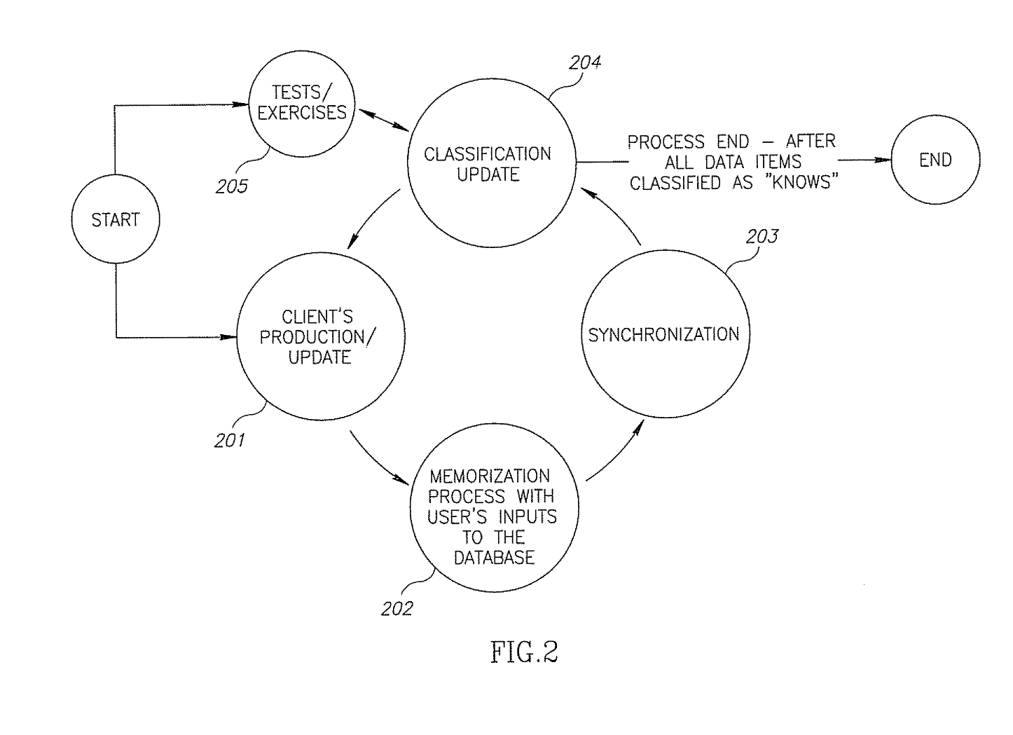

Reference is made to FIG. 2, which schematically illustrates a flow diagram of an exemplary implementation of the algorithm used by the teaching system in accordance with an embodiment of the invention

### Client's Production/Update [Step 201]:

The system enables the user to produce/configure the clients so that the data items to be downloaded from the server may be profiled and sorted according to the user's requirements. The databases of the clients are updated by loading/synchronizing the latest data items from the server database. Each client comprises one or more of the following features and capabilities: textual display of the data items; audio playback of the information; visual display of the information; video playback of the information; test execution capabilities; user input storage capabilities such as “marking” data items, using data input means such as, for example, buttons, mouse, electronic pencil, touch screen, barcode reading, voice command, and/or any combination thereof.

Memorization Process with User's Inputs to the Database [Step 202]:

The user is able to produce different filtering queries of data items through the use of the dynamically updated knowledge levels and the data items characteristics stored in the database. Additionally, the user may select the repetition frequency of data items in the memorization process. The user is also aware of the current knowledge level of each and every data item in the clients. Differentiation between the levels is done by the use of typical methods of emphasis such as, for example, textual emphasis in the form of different colors and/or italic/bold/underlining, vocal emphasis in the form of tones and/or sounds and/or vocal signatures and/or vocal effects, visual emphasis, and/or any combination thereof.

### Synchronization [Step 203]:

Depending on the type of client, the client and the central server may be continuously synchronized and/or periodically synchronized and/or manually synchronized so that the data items are downloaded from the central server to the client's database. Information input to the client by the user is transferred to the server during each synchronization process.

### Classification Update [Step 204]:

The classification process is done automatically by the system without user intervention. Bach data item in the database is set with an initial value equal to the lowest knowledge level. The system performs logical weighting of multiple users' inputs received from different clients through tests and exercises and then classifies the knowledge level of each and every item in accordance with the weighting. Each data item is classified according to one of the three knowledge levels, “knows”, “knows partially”, or “do not know”. The classification process is iterative, and is done each time there is a user input. The classification process ends with the converging of the memorization process when each and every data item is classified at the highest knowledge level.

### Tests/Exercises [Step 205]:

The system provides the user with tools that aid learning and help to classify the knowledge level of the user. This is done through the use of tests and exercises. The user defines a range of items on which he would like to be tested or reviewed as part of an exercise, for example, all the words that start with the same letter, or all three word letters. Additionally or alternatively, the range of items may be defined according to subject, or; optionally, according to sub-subject. The user then selects the order, through a secondary sorting, in which the questions will be presented, for example, randomly, sorted alphabetically, sorted by number of letters. The user then sets the number of questions in the test/exercise. The system uses the knowledge levels of the user, previously stored in the database, in order to determine a primary sorting of the order of the questions. Primary sorting is done starting from the lowest knowledge level to the highest, focusing on the user's weaknesses. Each question relates to a single data item, which is automatically built by the system based on the following method:

a. Present data item's “information portion” without the “information portion meaning”. User must provide feedback as to whether the information portion is recognized by the user or not recognized, by inputting “recognize” or “not recognize”, respectively.
b. If the user recognizes the information portion then 4 multiple answers are presented, the answers based on the following criteria: one is a correct answer, one is an antonym if it exists in the database, one is a synonym if it exists in the database, one is randomly chosen from the database. If the antonym and/or synonym do not exist in the database the answer is chosen randomly from the database.

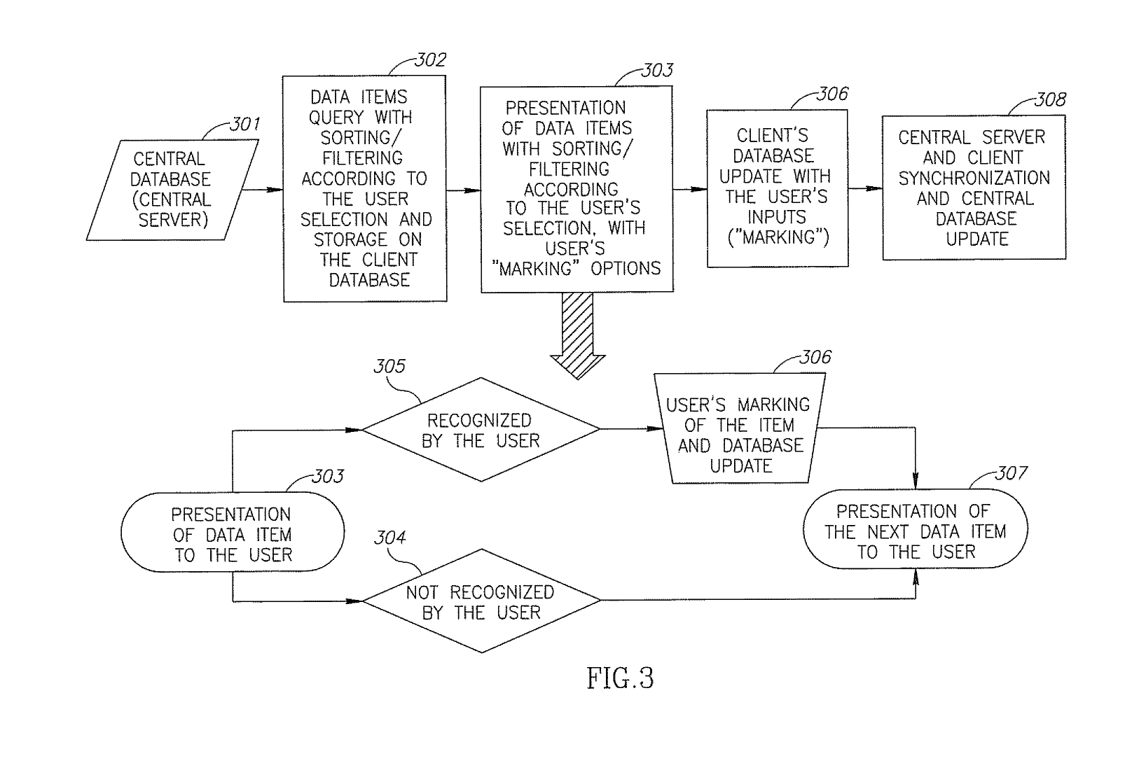

Reference is made to FIG. 3, which schematically illustrates a flow diagram of an exemplary implementation of the client's database management algorithm used by the teaching system in accordance with an embodiment of the invention.

The data items are stored in the server database [STEP 301], In response to a user query the data items are filtered and sorted according to the user's instructions and stored on the client's database [STEP 302]. The information portion of the data item, which has been previously filtered and sorted is then presented to the user [STEP 303]. The user indicates if the information portion is “not recognize” [STEP 304] or “recognize” [STEP 305]. If not recognized a new data item is presented [STEP 307] If recognized the data item is “marked” and given a marking score, the score dependent on whether the user's answer to the question related to the data item is correct or incorrect, and based on the number of times the data item has been reviewed by the user. The client's database is updated with the marking score of the data item [STEP 306]. A new data item is presented [STEP 307, return to STEP 303]. The process continues until all data items to be memorized during an exercise review session have been reviewed at least one time, and the marking scores are stored in client's database. Upon completion of the review session the synchronization takes place between the client and the server, updating the server database. Optionally, in some embodiments of the invention, synchronization is continuous so that the server database is being continuously updated, while in other embodiments the synchronization is periodic so that the server database is periodically updated according to a predefined user scheduling. Furthermore, in some embodiments of the invention the synchronization is manual so that the server database is updated only when initiated by the user [STEP 308].

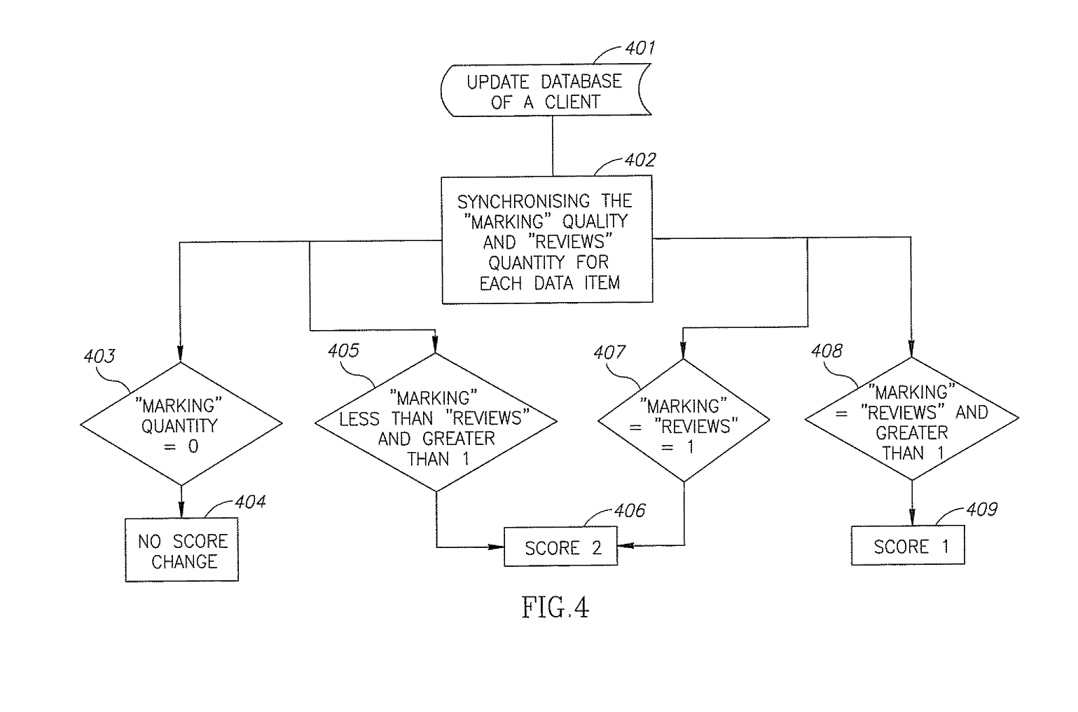

Reference is made to FIG. 4, which schematically illustrates a flow diagram of an exemplary implementation of a client's knowledge level scoring (marking) algorithm used by the teaching system in accordance with an embodiment of the invention. The algorithm considers four possible conditions.

The client's database is updated from the server database [STEP 401]. Synchronization between the server and the client transfers to client's database information regarding the number of times each data item has been marked and the number of times each data item has been reviewed by the user [STEP 402]

a. The first possible condition is that a data item is presented and the client database shows that the data item has never been marked [STEP 403]. The data item, independent of whether the user responds correctly or incorrectly to a question, is not given a marking score [STEP 404].
b. The second possible condition is that the data item is presented and the client database shows that the data item has been marled more than once before, but the number of markings is less than the number of times the data item has been reviewed by the user [STEP 405]. A marking score of 2 is given to the data item [STEP 406].
c. The third possible condition is that the data item is presented and the client database shows that the data item has been marked only once before and has been reviewed only once before [STEP 4071] A marking score of 2 is given to the data item [STEP 406].
d. The fourth possible condition is that the data item is presented and the client database shows that the data item has been marked every time it has been reviewed, and that it has been reviewed more than once [STEP 408]. A marking score of 1 is given to the data item [STEP 409].

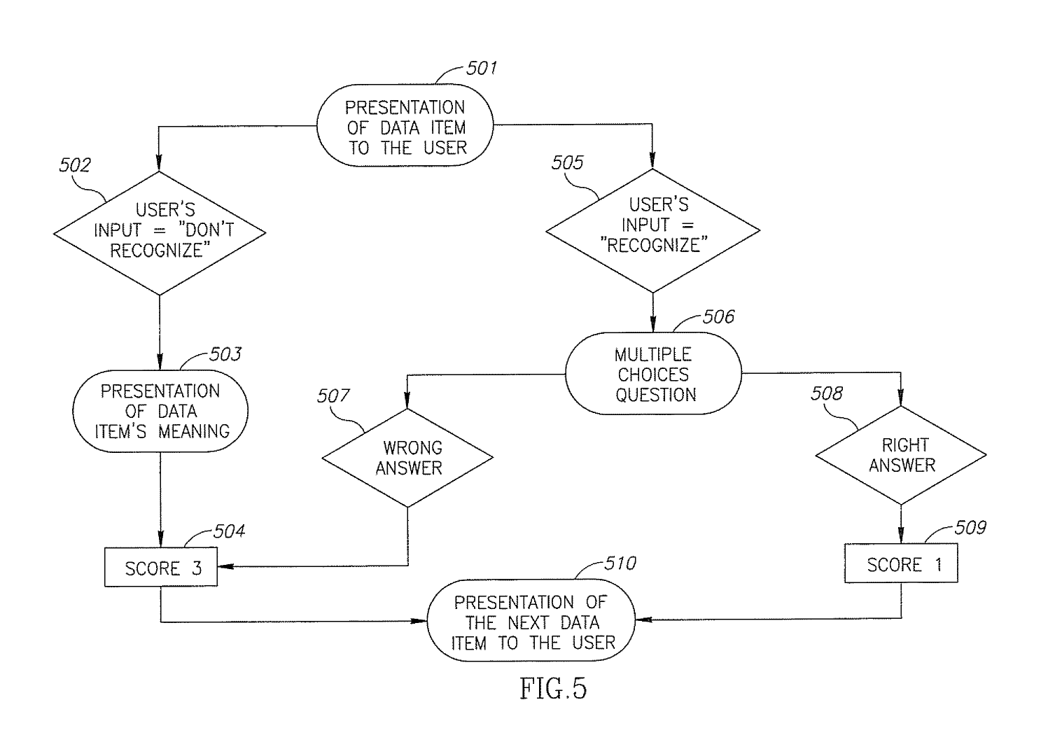

Reference is made to FIG. 5, which schematically illustrates a flow diagram of an exemplary implementation of a test knowledge level scoring (question) algorithm used by the teaching system in accordance with an embodiment of the invention. The algorithm considers three possible conditions.

a. A data item is presented to the user during a test session [STEP 501]. The first possible condition is that the user, after reviewing the information portion of the data item, inputs “do not recognize” [STEP 502]. The information portion meaning is then presented [STEP 503]. The data item is assigned a question score of 3 [STEP 504]. The next data item is then presented to the user [STEP 510—return to STEP 501].
b. The second possible condition is that the user, after reviewing the information portion of the data item, inputs “recognize” [STEP 505]. The user is then presented with four multiple choice questions [STEP 506] and responds with a wrong answer [STEP 507]. The data item is assigned a question score of 3 [STEP 504]. The next data item is then presented to the user [STEP 510 return to STEP 501].
c. The third possible condition is that the user, after reviewing the information portion of the data item, inputs “recognize” [STEP 5051] The user is then presented with the four multiple choice questions [STEP 506] and the user responds with the correct answer [STEP 508]. The data item is assigned a question score of 1 [STEP 509]. The next data item is then presented to the user [STEP 510—return to STEP 501].

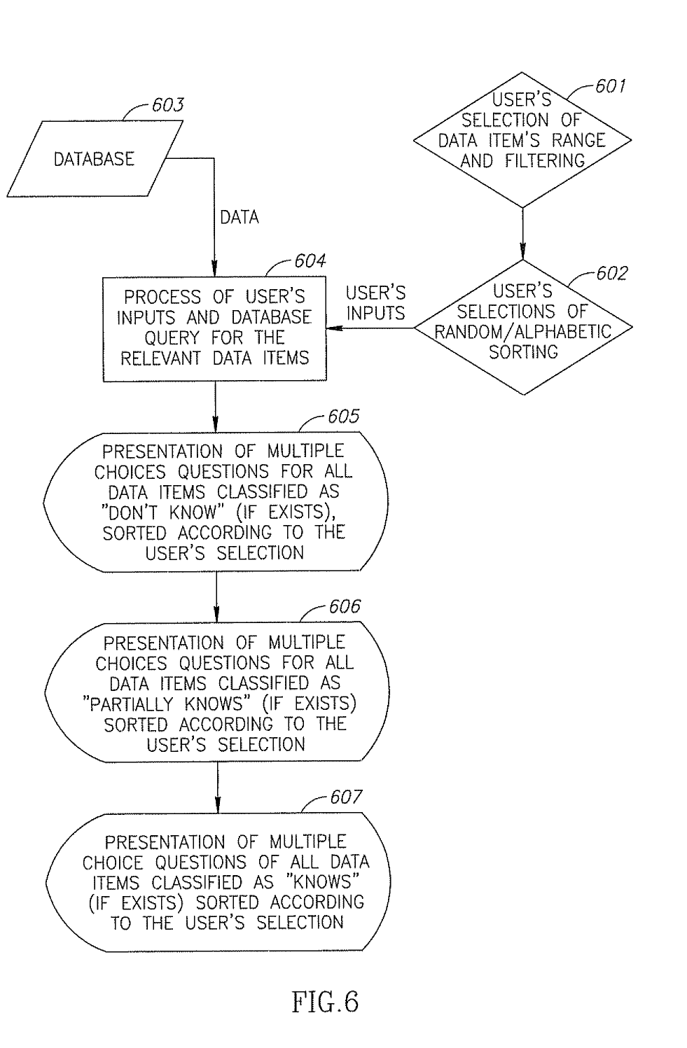

Reference is made to FIG. 6, which schematically illustrates a flow diagram of an exemplary implementation of an automatic test building algorithm used by the teaching system in accordance with an embodiment of the invention.

The user defines a range of data items on which he would like to be tested and produces the filter queries for the data items [STEP 601]. The user then selects the order, through the secondary sorting, in which the questions related to the data items will be presented [STEP 602]. The range, filter queries and sorting input parameters for the data items are received by the server database [STEP 603]. The server database processes the user's input parameters and transfers the relevant data items to the client's database [STEP 604]. If there are any data items classified as “do not know” the user is first presented with multiple choice questions relevant to these data items [STEP 605]. Following, if there are any data items classified as “know partially” the user is then presented with multiple choice questions for these data items [STEP 606]. Finally, if there are any data items classified as “knows” the user is then presented with multiple choice questions for these data items [STEP 607].

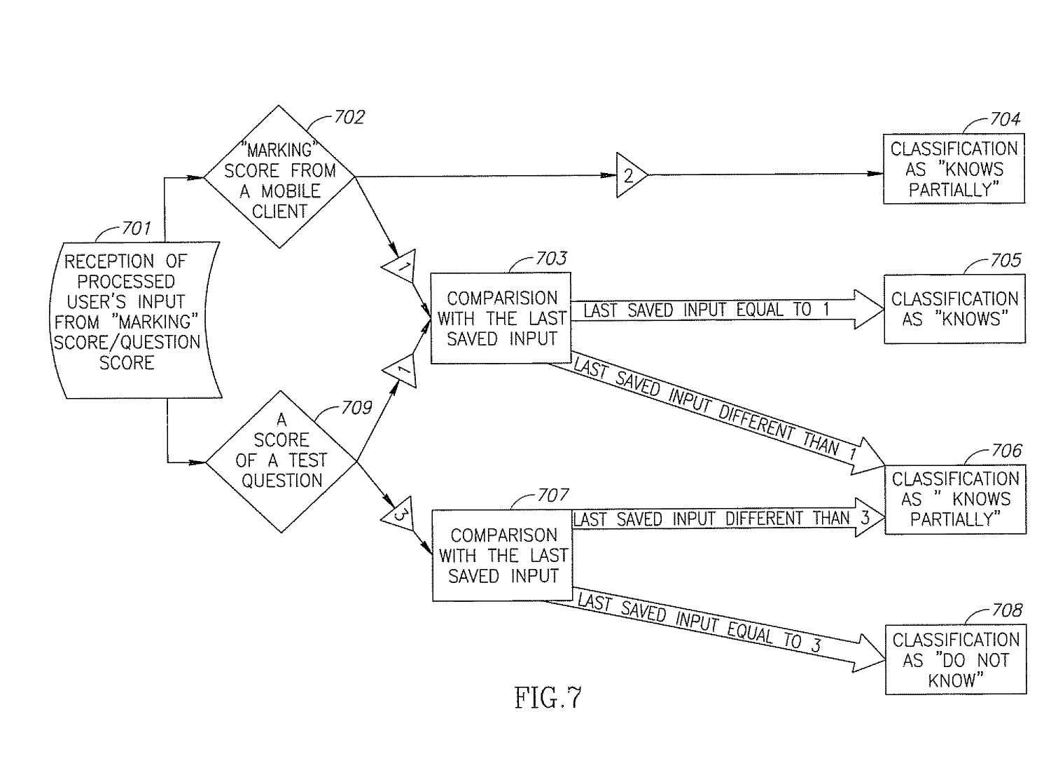

Reference is made to FIG. 7, which schematically illustrates a flow diagram of an exemplary implementation of the knowledge levels classification algorithm used by the teaching system in accordance with an embodiment of the invention.

An input is received from the user in the system in response to a question in a test or an exercise [STEP 701]. If the input is associated with an exercise it is registered by the system as a marking score. If the user knows the answer, a marking score is registered based on the client's knowledge level scoring (marking) algorithm shown in FIG. 4 [STEP 7021] A marking score of 2 is classified knowledge level “knows partially” [STEP 704]. If a marking score of 1 is registered it is compared with a question score last registered for the same data item in a previous test [STEP 703]. If the last previous question score was a 1 the data item is classified as “knows” [STEP 705]. If the last previous question score was not a 1 the data item is classified as “knows partially” [STEP 706].

If the input is associated with a test it is registered by the system as a question score [STEP 709]. If the user responded correctly in the test a question score of 1 is registered and is compared with the marking score last registered for the same data item in a previous exercise [STEP 703]. If the previous marking score was a 1 the data item is classified as “knows” [STEP 705]. If the previous marking score was not a 1 the data item is classified as “knows partially” [STEP 706] If the user responded incorrectly in the test a question score of 3 is registered and is compared with the with the question score last registered for the same data item in a previous test [STEP 707]. If the previous registered score was a 1 the data item is classified as “knows partially” [STEP 706]. If the previous registered score was not a 1 the data item is classified as “do not know” [STEP 708].

In the description and claims of embodiments of the present invention, each of the words, “comprise” “include” and “have”, and forms thereof, are not necessarily limited to members in a list with which the words may be associated.

The invention has been described using various detailed descriptions of embodiments thereof that are provided by way of example and are not intended to limit the scope of the invention. The described embodiments may comprise different features, not all of which are required in all embodiments of the invention. Some embodiments of the invention utilize only some of the features or possible combinations of the features. Variations of embodiments of the invention that are described and embodiments of the invention comprising different combinations of features noted in the described embodiments will occur to persons with skill in the art. The scope of the invention is limited only by the claims.

1. A teaching system comprising:
a database including multiple question/answer sets, wherein substantially each question/answer set includes a question and at least one correct answer, and wherein at least two sets are adapted to test substantially a same data item; and
a presentation module adapted to present to a user a second question/answer set relating to a first data item, immediately following or subsequent to the user correctly responding to a first question/answer set relating to the first data item, and said presentation module further adapted to stop presenting question/answer sets relating to the first data item once the user has responded correctly to two question/answer sets relating to the first data item without incorrectly responding to a question/answer set on the first data item.

2. The teaching system according to claim 1, further comprising at least one data storage device.

3. The teaching system according to claim 2, wherein said data storage device comprises an immobile data storage device

4. The teaching system according to claim 2, wherein said data storage device is a client.

5. The teaching system according to claim 4, wherein said database is synchronized with a database comprised in the client.

6. The teaching system according to claim 4, wherein data items are downloaded from said database to the client based on ranking, filtering, and sorting requirements of a user.

7. The client according to claim 6, wherein the client is adapted to mark a data item and to score the data item using a scoring system based on the number of marks and the number of times the data item has been reviewed by a user.

8. The teaching system according to claim 1, wherein said database stores the knowledge level of a data item.

9. The teaching system according to claim 1, wherein said presentation module is further adapted to classify a data item according to a knowledge level.

10. The teaching system according to claim 9, wherein the knowledge level is a function of any combination of a score issued to a data item, a test result, and an exercise review session.

11. A teaching method comprising:
using a database including multiple question/answer sets, wherein substantially each question/answer set includes a question and at least one correct answer, and wherein at least two sets are adapted to test substantially a same data item; and
presenting to a user a second question/answer set relating to a first data item, immediately following or subsequent to the user correctly responding to a first question/answer set relating to the first data item, and said presentation module further adapted to stop presenting question/answer sets relating to the first data item once the user has responded correctly to two question/answer sets relating to the first data item without incorrectly responding to a question/answer set on the first data item.

12. The teaching method according to claim 1, further comprising using at least one data storage device.

13. The teaching method according to claim 11, wherein said data storage device comprises an immobile data storage device.

14. The teaching method according to claim 11, wherein said data storage device is a client.

15. The teaching method according to claim 14, further comprising synchronizing said database with a database comprised in the client.

16. The teaching method according to claim 15, wherein downloading a data item from said database to the client is based on the ranking, filtering, and sorting requirements of a user.

17. The teaching method according to claim 11, further comprising marking a data item and scoring the data item using a scoring system based on the number of marks and the number of times the data item has been reviewed by a user.

18. The teaching method according to claim 11, further comprising storing the knowledge level of a data item in said database.

19. The teaching method according to claim 16, further comprising classifying each data item according to a knowledge level.

20. The teaching method according to claim 19, wherein the knowledge level is a function of a combination of the score issued to a data item, test results, and exercise review sessions.
